(19) United States
(12) Patent Application Publication
(10) Pub. No.: US 2018/0147482 A1
(43) Pub. Date: May 31, 2018

(54) Word Forming, Strategy and Chance Game

(71) Applicant: Robert J. Gulotty, JR., Greer, SC (US)

(72) Inventor: Robert J. Gulotty, JR., Greer, SC (US)

(21) Appl. No.: 15/361,418

(22) Filed: Nov. 26, 2016

(51) Int. Cl. A63F 3/04; A63F 13/822; A63F 1/04; A63F 13/92

(52) U.S. Cl. CPC A63F 3/0423; A63F 13/822; A63F 1/04; A63F 2001/0416; A63F 2003/0426; A63F 2300/807; A63F 13/92

(57) ABSTRACT

This invention is a novel game that combines player skills in forming large words, strategy and chance. The game utilizes physical or virtual single letter tiles, a game board and chance types as game components. The goal of the game is to get the most points. Letter tiles are used to create words and points are assigned for these words based on the product of the number of letters in the word and the number on a multiplier chance type. Multiplier chance types can be positive or negative whole numbers, or zero. Large words can be easily made from a large number of letter tiles per player turn, a large pool of letter tiles, and a large number of spaces on the board. Bonus word, swap tile and bankrupt chance types add chance to the player scores. The chance types make the game more enjoyable than other word forming games.

### BACKGROUND

Many existing word forming games such as Scrabble® have single letter tiles imprinted with the letters of an alphabet such as English, Spanish, etc. Players randomly select up to 7 single letter tiles from a pool of 100 tiles and place the tiles on a board to form one or more words. Typically, players must form a word using a single letter tile in a previously formed word. Players may replenish the number of letters previously used to form a word by drawing the same number of single letter tiles from the pool of single letter tiles at the end of each turn.

The quantity of each vowel or consonant in the pool of single letter tiles usually reflects the relative frequency of use of each of the letters as they appear in the words of the language. Similarly, the number of points assigned to each tile is related to the scarcity of the letter, with common letters such as the letter E being worth 1 point, and less common letters such as Z being worth 10 points. The number of points awarded for playing a word related to the sum of the letter values for the letters in the word. Further, the points accrued for each letter in the word may be doubled or tripled by placement of the letter on a “Premium space” on the board which doubles or triples the points based on the value of the letter. In Scrabble®, the number of single letter tiles a player may use to make a word in a given turn is limited to seven new tiles. It is often challenging to make a word from these few tiles. In addition, much of the strategy is based on the placement of high value single letter tiles on “Premium tiles.” Although it is possible to add the seven new tiles to an existing word on the board to make a larger word, it is generally less common and very challenging to make large words. Short words such as Qi or Za are often used to make the most points by placing these words on Premium tiles, and potentially in two directions by building on an i or a that is already on the board. Often those with better word forming skills are frustrated by Scrabble® and similar word games, as the placement strategies often win over better word forming skills. On the other hand, those with less good word forming skills are also frustrated by those with better word forming skills. The object of this invention is to make a word forming game that is more enjoyable to both those with high word forming skills and to those with less word forming skills. Further it is an aim of this invention to have a game which allows the players to improve their word forming skills, particularly for larger words. The word forming game of this invention is novel and substantially different from Scrabble® and other word forming games.

### FIELD OF THE INVENTION

The field of the present invention relates to games and more specifically to word forming games.

### DESCRIPTION OF RELATED ART

Brunot et al. (U.S. Pat. No. 2,752,158) disclosed a patent which is related to the popular Scrabble® game, specifically the use of Premium spaces that double or triple the value of the letters in the word. The invention of Brunot differs from this invention, there are no Premium spaces on the game board. In addition, this invention uses a second novel aspect whereby chance is used one of two factors in the calculations of points per player turn.

Marsoni et al. (U.S. Pat. No. 4,055,348) discloses the use of chance device to display letters in a word game, where two displayed letters are then used by game participants to make a word. Wakefield (U.S. Pat. No. 5,769,421) discloses using a six-sided die in combination with a four-section board to select letters which players use to form words. While chance is used to select letters that are used for word creation in Marsoni and Wakefield, this invention differs in that the chance is used after the word creation process to make a game where chance modifies the outcome. These two prior art pieces use chance to make the word formation process more difficult, in contrast, this invention gives the players larger numbers of letters to make words, and a large number of board spaces, making word formation easier.

### SUMMARY

The present invention overcomes these and other limitations of known word forming games by improving the ability of any player to make large words and by adding chance elements to the game. In this invention, a larger pool of single letter tiles, a larger number of single letter tiles used in each player turn and a larger number of spaces on the game board are used to make it easier to make large words. In addition, elements of chance are added to each turn which adjusts the points earned for the played word or words higher, lower, to zero, or negative. The enhanced ability to make large words and the use of chance levels the playing field for all players, making the game fun for more people.

### DETAILED DESCRIPTION OF THE INVENTION

In the preferred embodiment of this game, the player selects 16 tiles from a pool of 300 single letter tiles. The board has 625 board spaces, in a square shape with 25 rows and 25 columns of spaces which can hold one single letter tile. Following the placement of one or more single letter tiles to make a word on the game board, a chance type is selected. For example, in the form of a chance card. One type of chance card is a multiplier with whole number values, such as 1, 2, 3, 4, 5, 6, 7, 8, 9, 0, −5, −10. If a chance card with the number 3 is chosen, then the points earned for the word is three times the number of letters in the word played. On the other hand, if the number 0 is selected, there would be no points awarded. Further, if the number −10 is chosen, then a negative score would result, −10 times the number of letters in the word or words played.

Another part of this preferred embodiment is the use of other chance types, such as a bankrupt chance type, which is put in the card deck if 3 or more players are in the game. Selecting the bankrupt card adjusts the players total score to zero if it is selected. Other chance types in the preferred embodiment are a swap tile chance type, which results in each player giving their current single letter tiles in their hand to the player to their left, and a bonus chance type, which allows the player to add another word to the board during the same turn. The player may also pass or skip their turn, or replace one or more of their single letter tiles with a new letter tile in the tile pool as their turn, instead of making a word.

The game may be played on various media, including but not limited to, physical media, electronic game consoles, computers, and interactive and social media networks accessed using computers, cellular devices, tablets, etc.

The following examples further illustrate the apparatus and method of play of this invention.

### Example 1. Apparatus

The following items are an example of an apparatus as a working example of this invention:

1. A rectangular game board comprised of 800 spaces, 40 spaces wide by 20 spaces high.

2. Four hundred single letter tiles comprised of the following distribution of single letter tiles: A-30, B-8, C-12, D-16, E-48, F-8, G-10, H-10, I-26, J-4, K-4, L-14, M-12, N-26, O-30, P-8, O-4, R-26, S-20, T-30, U-14, V-6, W-8, X-4, Y-8, Z-4, blank-10.

3. Fifty chance type cards comprised of the following distribution of card types (format chance type-number of that type):

Bonus word-4, Swap tiles-1, Bankrupt-1, 0-2, 1-6, 2-6, 3-5, 4-5, 5-4, 6-4, 7-3, 8-3, 9-3, −5-2, −10-1.

### Example 2. Method of Play

The following steps are an example of the method of play as taught in this invention. The Apparatus in Example 1 was used for this example. There are four players in this example game.

The method of play in this example consists of the following steps:

1. Each player selects one tile from the letter tile pool. The person with the highest letter of the alphabet earned to right to play first.

2. Each player selected 16 single letter tiles from the letter tile pool starting with the first player and the next player to the left.

3. The first player places 8 single letter tiles on the board to form a word.

4. The first player then draws a chance type card, it was a multiplier card with value 3.

5. The first player records a score of 24 based on a product of the number of single letter tiles in the word (8) and the number of the multiplier card (3).

6. The first player replenishes the 8 single letter tiles from the single letter tile pool for their next play.

7. The second player played a word using one of the letters from the word on the board and an additional 6 new letters from the 16 single letter tiles of the player.

8. The second player then draws a multiplier card with the number 7.

9. The second player records a score of 49 based on a product of the number of single letter tiles in the word formed (7) and the number of the multiplier card (7).

10. The second player replenishes the 6 single letter tiles from the single letter tile pool for their next play.

11. The steps above were repeated for the third and fourth player and the four players continue taking turns until the game ends.

The following steps are representative of a few other examples of play for different representative situations as defined in this invention:

These next steps illustrate the play when a player selects a multiplier card with a negative number:

12. A player formed an 8 letter word on the board.

13. This player drew a multiplier card with the number −10.

14. This player recorded a score of −80 based on a product of the number of single letter tiles in the words formed (8) and the number of the multiplier card (−10).

15. The total score of this is now 80 points less than it was at the start of the turn.

16. In this situation, the players total score may be negative and it may take one or more turns for the total score of this player to become positive.

These next steps illustrate the play when a player forms two words using an S at the end of a word that is on the board during a player turn:

17. A player places a 9 letter word starting with an S at the end of an 8 letter word that was on the board.

18. This player draws a multiplier card with the number 2.

19. This player records a score of 36 based on a product of the number of letter tiles in the two words formed (18) and the number of the multiplier card (2).

These next steps illustrate the play when a Bonus chance type card is selected during a player turn:

20. A player makes an 11 letter word on the board.

21. This player draws a Bonus type chance card and added a second word of 5 letters on the board.

22. This player draws a multiplier card with the number 0.

23. This player records a score of 0 based on a product of the number of letter tiles in the words formed (16) and the number of the multiplier card (0).

These next steps illustrate the play when a swap tiles type chance card is selected during a player turn;

24. A player makes a 7 letter word on the board.

25. This player draws a swap tiles type chance card and each player gives their current letter tiles to the player to their left.

26. This player draws a multiplier card with the number 4.

27. This player recorded a score of 28 based on a product of the number of letter tiles in the word formed (7) and the number of the multiplier card (4).

28. The player to the left replenished the 6 missing tiles and the game continued as their turn.

These next steps illustrate the play when a bankrupt type chance card is selected during a player turn;

29. A player makes a 10 letter word on the board.

30. This player draws a bankrupt type chance card.

31. This player records a score of 0 for the turn and their total score was adjusted to 0.

32. The game Continues, including the bankrupt player who continues to play as before receiving the bankrupt card.

These next steps illustrate the play to end the game by a player earning 500 points:

33. A player has 475 points at the start of their turn and makes a 9 letter word on the board.

34. This player then draws a multiplier card with the number 3.

35. This player recorded a score of 27 based on a product of the number of letter tiles in the word formed (9) and the number of the multiplier card (3).

36. This player is the first to achieve greater 500 points so the game is over and this player wins the game.

These next steps illustrate the play to end the game by depletion of the letter tiles in the letter tile pool:

37. A player made a 9 fetter word on the board.

38. This player then drew a multiplier card with the number 3.

39. This player recorded a score of 27 based on a product of the number of letter tiles in the word formed (9) and the number of the multiplier card (3).

40. This player was only able to replenish 5 of the missing tiles because the letter tile pool is empty.

41. The game is now over as there are no letter tiles left in the tile pool and the player with the highest number of points wins.

The invention claimed is:

1. A word forming game with method of play which comprises forming words and and one or more elements of chance.

2. A word forming game apparatus of claim 1, which is a physical or virtual game.

3. A word forming game apparatus of claim 2 comprising:
a. a pool of 200 or more single letter tiles including the alphabet of the English or other language and one or more blank tiles,
b. a game board containing 400 or more board spaces which allow the placement of letter tiles to form words of one or more letter tiles or are spaces that can't be used for letters,
c. one or more chance types,
d. one or more players who take turns playing the game,
e. a method of calculating points per turn which involves both word formation and chance.

4. A method of play of claim 1 which comprises:
a. players placing one or more of the single letter tiles on the game board in the available board spaces to create a word or words and selecting a chance type,
b. players using up to 8 or more single letter tiles to form words in each turn,
c. the game points earned during the player turn is calculated as the product of the number of single letter tiles in the word or words played multiplied by the numerical value of the multiplier chance type selected during the turn,
d. the end of the game occurs when no tiles remain to be played, or if all of the players in the game have passed once, or a if specified number of points have been earned by a player,
e. the player with the most points at the end of the game is the winner of the game.

5. A method of play of claim 1 comprising chance types comprised of multipliers which have a whole number numerical value which can be positive, zero or negative.

6. A method of play of claim 1 comprising a bonus word chance type lets the player place another word on the game board during their turn.

7. A method of play of claim 1 comprising a swap tiles chance type causes each player to exchange their single letter tiles with the player to their left.

8. A method of play of claim 1 comprising a bankrupt chance type being added the game with the other chance types, which causes the total earned game points of the player drawing the bankrupt card to be zero.

9. A word forming game apparatus of claim 2 comprising chance types in the form of one or more playing cards.

10. A word forming game apparatus of claim 2 comprising chance types in the form of a wheel with one or more spaces containing chance types.

11. A word forming game apparatus of claim 2 comprising chance types in the form of one or more of:
a. spinner,
b. special dice,
c. other physical or electronic forms of the chance types of this invention.

12. A method of play of claim 1 which comprises the player choosing not to play a word and exchanging zero or more single letter tiles to the letter pool for their turn.

13. A method of play of claim 1 which comprises players using up to 16 single letter tiles during each turn.

14. A word forming game apparatus of claim 2 comprising multiplier chance types with numerical values that are positive, negative, and/or zero.

15. A word forming game apparatus of claim 2 comprising multiplier chance types with numerical values of −10, −5, 0, 1, 2, 3, 4, 5, 6, 7, 8 and/or 9.

16. A word forming game apparatus of claim 2 comprising one or more chance types:
a. Bonus word,
b. Swap tiles,
c. Bankrupt.

17. A word forming game apparatus of claim 2 comprising:
a. 300 single letter tiles,
b. 50 chance type cards.

18. A word forming game apparatus of claim 2 comprising:
a. 625 board spaces,
b. a square game board shape with 25 board spaces wide and 25 board spaces high.

19. A word forming game apparatus of claim 2 comprising:
a. 800 board spaces,
b. 400 single letter tiles,
c. a rectangular game board with 40 board spaces wide and 20 board spaces high.

20. A word forming game apparatus of claim 2 comprising:
a. 841 board spaces
b. 400 single letter tiles.
c. a game board with 29 board spaces wide and 29 board spaces high.
